(19) United States
(12) Patent Application Publication
(10) Pub. No.: US 2009/0026763 A1
(43) Pub. Date: Jan. 29, 2009

(54) Sliding Sealing Connector

(75) Inventors: Zlatomir Kircanski, Cumberland, RI (US); Friedrich Gugel, Roth/Eckersmunhlen (DE)

Correspondence Address: MAURICE M KLEE, 1951 BURR STREET, FAIRFIELD, CT, 06824, US

(73) Assignee: ACS Industries, Inc., Lincoln, RI (US)

(21) Appl. No.: 12/224,704

(22) PCT Filed: Mar. 6, 2007
(86) PCT No.: PCT/US07/05617

§ 371 Date: Sep. 4, 2008

Related U.S. Application Data
(60) Provisional application No. 60/779,502, filed on Mar. 6, 2006.

(51) Int. Cl. F16L 17/00

(52) U.S. Cl. 285/375

(57) ABSTRACT

Two gas conduits of different sizes are connected in a sliding arrangement using a combination of a seal and a bushing, each independently made from knitted wire mesh or wound wire. If a mesh is used, it can be impregnated with a filler, such as mica or graphite, for increased density. Especially useful for vehicle exhaust systems, the arrangement facilitates the use of after-market parts that may have different dimensions than OEM parts. This design slidably connects two gas conduits of different sizes and/or geometries.

### BACKGROUND OF THE INVENTION

1. Field of the Invention

This invention relates to a sliding joint connecting two gas conduits, and can be used in internal combustion engine exhaust system conduits, or in any gas conduit or piping system conducting hot gases.

2. The State of the Art

All internal combustion engines have an exhaust outlet. Those used for motorizing vehicles, such as cars and boats, whether using gasoline or diesel, also include an exhaust conduit for conducting the exhaust gases from the engine to an external vent. The exhaust gases can be “hot” (up to about 1000° C. for present gasoline consumer vehicles) or “cold” (which typically refers to diesel engines). Typically, the combustion gases from the cylinders are collected in the exhaust manifold and then pass through various apparatus that remove particulates (e.g., a diesel particulate filter), remove or catalyze the conversion of exhaust gases (e.g., catalytic converter), and deaden sound (e.g., a muffler). This conduit for the exhaust gases thus includes a number of parts that are connected together. These parts are metal and are designed for high operating temperature, so there is expansion as the engine warms up and contraction after the engine is shut off. In fact, the tail pipe is typically designed to be flush with the rear bumper, but in a cold car it may be some distance from the bumper and under the car. Various types of seals are used between and within these metal parts. Some parts are close fitting, and some are connected with a flexible seal. Seals within various parts include those that support and cushion the catalytic converter ceramic monolith (the “brick”), housed in a metal “can”, direct the hot exhaust gases through the catalytic converter or diesel particulate filter (DPF).

It is generally known that seals and/or gaskets which are suitable for some applications can be made from compacted knitted-wire elements. Seals and gaskets have been produced comprising elements which are made by knitting or winding wire to form a sheet or a knitted or wound tube, rolling the sheet or tube to form a roll or a ring of knitted or wound wire, and then compressing the roll or ring to form a compacted wire element. Knitted wire elements of this type have been utilized as the core elements for seals, wherein they are covered with fiberglass fabrics for providing reduced leakage rates. Knitted-wire elements of the this type have also been utilized with various types of filler materials to provide reduced leakage rates so that they can then be used for other types of seals or gaskets. Filters have also been made from a wire windings, which can also be compressed, if desired.

It has been found that these compacted wire seals can be utilized effectively in applications wherein slow gas-leakage rates can be tolerated. In this connection, it has been found that because of the method by which these types of seals are formed, they have substantially reduced leakage rates in comparison with gaskets made from other types of compacted knitted-wire elements. By heating the knitted wire roll or ring in an atmosphere containing oxygen, oxides are produced on the surface of the wire. When the roll or ring of knitted wire is thereafter compressed, these oxides by filling in some of the void areas between wires in the mesh, result in a denser product having a reduced leakage rate for the seal. Reduction of leakage can also be achieved, instead of or in addition to oxidation, by impregnating the mesh with a filler material. When the knitted wire seal is formed into a V-shaped configuration, it has sufficient resiliency in the legs of the V-shape to compensate for minor irregularities in the surfaces of elements with which it is engaged or abutted. When the seal is mounted so that a first element is received in engagement with the inner periphery of the seal and a second element is received in engagement with the outer periphery thereof, the V-shape of the seal and the resiliency and flexibility of the compacted wire mesh construction allow it to be maintained in sealing engagement with the first and second elements regardless of irregularities in the surface configurations. The use of the V-shaped cross section thus has advantages when combined with the above-mentioned method of forming the seal.

U.S. Pat. No. 5,419,123 discloses an emission control device that can be slid onto the end of a tail pipe, the device including wire mesh filters.

U.S. Pat. No. 5,331,810 discloses a low thermal capacitance exhaust system having two pipes that slidably connect, one pipe having an inner diameter effective to abut the outer diameter of the connecting pipe, and a bellows surrounding the outside of the connection.

Among others, two of the problems with the general configuration of the exhaust conduit are the accommodation of thermal expansion and contraction, and in the after market and repair or warranty service, making sure that replacement parts fit well.

### SUMMARY OF THE INVENTION

In light of the foregoing, one of the objects of this invention is to provide a connecting sealing structure that accommodates thermal expansion and contraction and maintains its sealing characteristics at both high and low temperatures.

Another object of this invention is to accommodate after market and repair and warranty replacement parts that may not have the same tolerance or fit as the original equipment.

Still another object of this invention is to provide a connecting seal that can be of an adjustable length, such as to accommodate replacement parts different than the OEM parts.

Yet another object of this invention is to provide a connecting seal that can accommodate differences in angle (alignment) between the exhaust system components.

Still yet another object of this invention is to provide a connecting seal fulfilling these objects at a low cost and simple design.

In this invention, two gas conduits of different sizes are connected in a sliding arrangement using a combination of a seal and a bushing, each independently made from knitted wire mesh or wound wire. If a mesh is used, it can be impregnated with a filler, such as mica or graphite, for increased density. Especially useful for vehicle exhaust systems, the arrangement facilitates the use of after-market parts that may have different dimensions than OEM parts. This design slidably connects two gas conduits of different sizes and/or geometries using a sliding arrangement having a combination of a wire mesh seal and a wire mesh bushing, especially knitted wire mesh. The mesh can be impregnated with a filler, such as mica or graphite, for increased density. Especially useful for vehicle exhaust systems, the arrangement facilitates the use of after-market parts that may have different dimensions than OEM parts.

In a particular embodiment, this invention provides a sealing structure for an exhaust system for an internal combustion engine comprising (a) a first larger conduit and a second smaller conduit having different diameters, the smaller conduit being at least partially disposed within the second conduit in an overlap region, (b) a knitted wire mesh primary seal disposed within the overlap region sealing the space between an inside of the first larger conduit and an outside of the second smaller conduit, and (c) a first knitted wire mesh bushing disposed within the overlap region between an inside of the first larger conduit and an outside of the second smaller conduit, wherein the first conduit and second conduit can slide past each other. The seal and/or bushing can be impregnated with a material for increased density and improved sealing characteristics.

Two gas conduits of different sizes are connected in a sliding arrangement using a combination of a seal and a bushing, each independently made from knitted wire mesh or wound wire. If a mesh is used, it can be impregnated with a filler, such as mica or graphite, for increased density. Especially useful for vehicle exhaust systems, the arrangement facilitates the use of after-market parts that may have different dimensions than OEM parts. In general, this design slidably connects two gas conduits.

### BRIEF DESCRIPTION OF THE FIGURE

FIG. 1 depicts an idealized cross section of an embodiment of this invention.

### DESCRIPTION OF SPECIFIC EMBODIMENTS

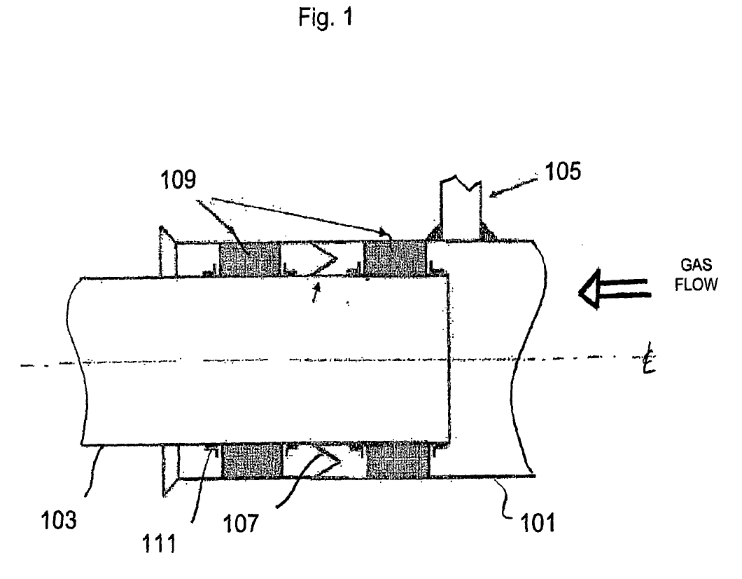

Part of a typical vehicle exhaust system is shown in FIG. 1, in which 101 is a first conduit such as the exhaust pipe, 103 is a second conduit, such as the intake to the catalytic converter. As shown, the first and second conduits have a different diameter; this invention will also function if the first and second conduits have different shapes (such as one being round and one being oval). The first conduit is typically suspended from a connector 105 that cooperates with a hanger on the underbody of the vehicle; although not shown, the second conduit (or the device to which it attaches, such as the catalytic converter) is similarly suspended. The arrow shows the direction of the gas flow, although the direction of flow can be in the opposite direction.

Between the two conduits is a seal 107. A V-shaped seal is preferable, such as that disclosed in U.S. Pat. No. 6,286,840 (the disclosure of which is incorporated herein by reference), although other seal geometries can also be used. As shown, the V-seal is a knitted wire mesh having a high density (at least 60%, and preferably about 75-80% theoretical density). The angle between the legs of the “V” is about 60° and typically ranges from 50° to 80°. The mesh can be impregnated with a filler, as described in the '840 patent, as well as in U.S. Pat. No. 6,533,977 and in US Pat. Pub. 20060144614. Suitable filler materials include mica, vermiculite, non-metallic fibers, graphite (including Graphoil-type flexible graphite), and the like, and combinations thereof, which are typically introduced by spraying or dipping the seal into a slurry and then drying. Filler materials can achieve an increase the density of the resulting seal to more than 80% of theoretical.

This dense seal 107 is the primary fluid (exhaust gas) seal directing the fluid from the first conduit into the second conduit. In the geometry and orientation shown, it can be seen that this seal can accommodate thermal expansion and contraction. That is, as the inner pipe expands, the legs of the V are forced together without compromising the seal characteristics.

On both sides (although one side may be sufficient) of the primary seal are wire mesh bushings 109, also made of knitted wire. These bushings are preferably about 50% dense and so are fairly compressible. As such, these bushings also accommodate thermal expansion and contraction. Each bushing is held in place by a pair of brackets 111 attached (e.g., welded, rivited) to the second conduit. Alternatively, the bushing (and optionally the V-seal) can be spot welded to the second conduit. The bushings are preferably knitted from high quality steel, even chrome steel, which may be heat treated and passivated. Alternatively, the bushings can be welded (e.g., spot-welded) to the inner pipe so that they are fixed to the inner, smaller diameter pipe.

The wire for the bushings is preferably a stainless steel wire, and preferably flattened, which is knit with a conventional knitting machine, and then optionally oxidized, as described in U.S. Pat. Nos. 4,683,010 and 6,286,840 (the disclosures of which are incorporated herein by reference), and finally pressed (molded) into the desired shape. As with the seal, one or both of the bushings can be impregnated with a filler material, the same or different from any used in the seal, to increase the density and reduce the leak rate. The wire, optionally flattened, can also be wound onto a mandrel and sintered into the desired bushing shape, preferably after being removed from the mandrel. Combinations of these different types of bushings can be used together.

As seen in the structure of FIG. 1, the connecting seal allows a slidable connection between the two conduits, thereby accommodating both thermal expansion and differences in length as might occur with after market, service, and warranty replacement parts. Further, the compressibility of the bushings and the primary seal allows the two conduits to be connected even if their respective axes are not aligned. The combination of the ability to telescope and to accommodate off-angle connections provides improved safety in the case of an accident because the connection can expand, contract, and bend. Still another advantage is that no welding or crimping is needed to connect the two conduits together.

In the context of the exhaust system for an internal combustion engine having a muffler, the sliding seal connection can be placed between the two. Where a catalytic converter is present (usually between the engine and the muffler), a sliding seal disposed upstream of the converter preferably uses a seal, and optionally at least one bushing, that is impregnated to provide a denser seal and/or bushing structure. A sliding seal downstream of a catalytic converter may use a seal and/or bushing(s) that are not impregnated if the pressure characteristics of the system do not require a higher density seal and/or bushing to avoid leakage.

Although described herein with respect to a vehicle exhaust system, this invention is suitable for any gas conduit.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A sealing structure for an exhaust system for an internal combustion engine, comprising:
A. a first larger conduit and a second smaller conduit having different diameters, the smaller conduit being at least partially disposed within the second conduit in an overlap region;
B. a knitted wire mesh primary seal disposed within the overlap region sealing the space between an inside of the first larger conduit and an outside of the second smaller conduit;
C. a first knitted wire mesh bushing disposed within the overlap region between an inside of the first larger conduit and an outside of the second smaller conduit;
wherein the first conduit and second conduit can slide past each other.

2. The sealing structure of claim 1, further comprising a second knitted wire mesh bushing disposed within the overlap region between an inside of the first larger conduit and an outside of the second smaller conduit.

3. The sealing structure of claim 2, wherein the primary seal is axially disposed between the first and second bushings.

4. The sealing structure of claim 1, wherein the sealing structure is disposed between an engine and a catalytic converter, and the

5. The sealing structure of claim 1, wherein each conduit is metal.

6. The sealing structure of claim 1, further comprising a bracket attached to the second smaller conduit for positioning the bushing.

7. The sealing structure of claim 1, wherein the primary seal is a V-shaped wire mesh seal.

8. The sealing structure of claim 2, wherein the primary seal is a V-shaped wire mesh seal.

9. The sealing structure of claim 1, wherein the bushing has an oxidized surface.

10. The sealing structure of claim 2, wherein both bushings have an oxidized surface.

11. The sealing structure of claim 1, wherein the bushing is welded to the second smaller conduit.

12. The sealing structure of claim 2, wherein the bushing is welded to the second smaller conduit.

13. The sealing structure of claim 1, wherein the primary seal is impregnated.

14. The sealing structure of claim 13, wherein the impregnated material is mica, vermiculite, non-metallic fibers, graphite, and combinations thereof.

15. The sealing structure of claim 1, wherein the first knitted wire mesh bushing is impregnated.

16. The sealing structure of claim 15, wherein the impregnated material is mica, vermiculite, non-metallic fibers, graphite, and combinations thereof.

17. The sealing structure of claim 2, wherein both the first and second wire mesh bushings are impregnated.

18. The sealing structure of claim 17, wherein the impregnated materials for the first and second bushings are independently selected from mica, vermiculite, non-metallic fibers, graphite, and combinations thereof.

19. A slidable sealing structure, comprising: a first, smaller metal conduit having a pair of wire mesh bushings disposed orthogonally to the axis of the conduit along the outside of the conduit; a wire mesh seal between the bushings, and the smaller metal conduit, bushings, and seal disposed within a second, larger metal conduit, the conduits slidably connected.

20. The slidable sealing structure of claim 19, wherein the bushings and the seal are made of knitted wire mesh.

21. The slidable sealing structure of claim 20, wherein the bushings and the seal are impregnated with a material independently selected for each from mica, vermiculite, non-metallic fibers, graphite, and combinations thereof.
